(19) United States
(12) Patent Application Publication
(10) Pub. No.: US 2008/0025423 A1
(43) Pub. Date: Jan. 31, 2008

(54) COMMUNICATION SYSTEM

(75) Inventors: Haifend Wang, Oulu (FI); Wei Li, Nanjing (CN); Ming Chen, Nanjing (CN); Shixin Cheng, Nanjing (CN)

Correspondence Address: FOLEY & LARDNER LLP, P.O. BOX 80278, SAN DIEGO, CA, 92138-0278, US

(73) Assignee: Nokia Corporation

(21) Appl. No.: 11/738,315

(22) Filed: Apr. 20, 2007

(30) Foreign Application Priority Data
Jul. 31, 2006 (GB) 0615201.1

(51) Int. Cl. H04L 27/28

(52) U.S. Cl. 375/260

(57) ABSTRACT

A method for transmitting information in a communication system from a first station to a second station. The method includes modulating a first part of the information according to a first modulation scheme to provide a first modulated data block; modulating a second part of the information according to a second different modulation scheme to provide a second modulated data block; appending the first modulated data block to the second modulated data block to form a composite data block; and transmitting the data block.

### CROSS-REFERENCE TO RELATED PATENT APPLICATIONS

The present application claims priority to Great Britain Priority Application 0615201.1, filed Jul. 31, 2006, the specification, drawings, claims and abstract of which is incorporated herein by reference in its entirety.

### FIELD OF THE INVENTION

The present invention relates to communication systems and particularly, but not exclusively, to cyclic prefix-single carrier (CP-SC) systems.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Orthogonal frequency multiplexing is a block oriented modulation scheme that maps N data symbols into N orthogonal carriers separated by a distance of 1/T where T is the block period. As such, multi-carrier transmission systems use OFDM modulation to send data bits in parallel over multiple adjacent carriers. An advantage of multi-carrier transmission is that inter-block interference (IBI) due to signal dispersion in the transmission channel can be reduced by inserting a guard time interval between the transmission of subsequent blocks. The guard time is filled with a copy of the block (called a cyclic prefix) to preserve the orthogonality between the carriers. The cyclic prefix CP allows delayed copies of each block to die out before the succeeding block is received.

In an OFDM modulator the sum of the individual carriers correspond to a time domain wave form that can be generated using an Inverse Discrete Fourier Transform (IDFT). The Inverse Fast Fourier Transform (IFFT) is a well known efficient implementation of the IDFT that performs an N point IDFT transform. In general, the IFFT operation is performed in the transmitter before the CP is inserted into the signal.

Recently, Cyclic Prefix Assisted Single Carrier transmission (CP-SC) has been proposed as an alternative to OFDM and is a favourable candidate for a future communication standard. CP-SC combines a traditional single carrier transceiver with frequency domain (FDE) equalization in OFDM. The main difference between a CP-SC system and an OFDM system is that the IFFT is located in the CP-SC receiver instead of the transmitter.

In CP-SC, by inserting a CP with a length greater than the maximum delay spread, inter-block interference (IBI) can be totally removed and frequency domain equalization is possible with only one multiplication per data symbol (or one tap per sub-carrier in OFDM terminology). The performance of this scheme is essentially the same as for OFDM, but with enhanced robustness to nonlinear distortion and phase noise.

In a communication system, signals which are transmitted between a user equipment UE and a base station BS that are moving relative to one another are subject to the well known Doppler effect. The Doppler effect causes a frequency shift in the received frequency relative to the transmitted frequency. The Doppler shift is dependent upon the speed and direction of the movement of the user equipment UE relative to the base station BS.

In a fast fading channel, i.e. one in which the signal power changes over a very short distance, with high Doppler shift, the channel may vary in even one transmitted block. In conventional CP-SC and OFDM with one tap FDE, this causes inter symbol interference (ISI) and frequency domain inter-carrier interference (ICI).

Many algorithms have been proposed to compensate the system performance degradation due to high a Doppler shift. These can be classified into three main types:

Type I directly applies interference cancellation techniques of multi-user detection (MUD) which relate to Code Divisional Multiple Access (CDMA) systems. This type of algorithm suffers with the problem that it induces a processing delay due to multistage operations, and that the error propagation is sensitive to the accuracy of initial estimates of the transmitted signals.

Type II, referred to as self interference cancellation, compensates the ICI or ISI by increasing the signal redundancy. It has very low complexity but use of this algorithm decreases the bandwidth due to the increased signal redundancy.

Type III shortens the transmission block length with a smaller sized FFT operation. This results in a signal that is more robust to ISI and ICI. However since the length of the CP is dependent on the maximum delay spread, the size of the CP is not reduced. This reduces the system bandwidth efficiency due to overhead of cyclic prefix.

It is therefore an aim of embodiments of the present invention to provide a communication system able to resist ICI and ISI in a fast fading channel at high Doppler shift, with the same bandwidth efficiency as the conventional systems.

### SUMMARY OF THE INVENTION

According to a first aspect of the present invention there is provided a method for transmitting information in a communication system from a first station to a second station comprising modulating a first part of the information according to a first modulation scheme to provide a first modulated data block, modulating a second part of the information according to a second different modulation scheme to provide a second modulated data block, appending said first modulated data block to the second modulated data block to form a composite data block and transmitting the data block.

According to a second aspect of the present invention there is provided a method of receiving a composite data block sent from a first station to a second station comprising the steps of separating the component data blocks of the composite data block in dependence on the type of modulation scheme used to modulate the data in each component data block and demodulating each component data block using a demodulation scheme corresponding to the modulation scheme used to modulate the data.

According to a third aspect of the present invention there is provided a transmitter for transmitting information in a communication system comprising first modulating means for modulating a first part of the information according to a first modulation scheme to provide a first modulated data block, second modulating means for modulating a second part of the information according to a second modulation scheme to provide a second modulated data block, means for appending said first modulated data block to the second modulated data block to form a composite data block and transmitting means for transmitting said composite data block.

According to a fourth aspect of the present invention there is provided a receiver for receiving a composite data block sent from a first station to a second station comprising means for determining component data blocks of the composite data block in dependence on the type of modulation scheme used to modulate data in each of the component data blocks and demodulating means for demodulating each component data block using a demodulation scheme corresponding to the modulation scheme used to modulate the data.

According to a fifth aspect of the present invention there is provided a transmitter for transmitting information in a communication system comprising a first modulator for modulating a first part of the information according to a first modulation scheme to provide a first modulated data block, a second modulator for modulating a second part of the information according to a second different modulation scheme to provide a second modulated data block, a combiner for appending said first modulated data block to the second modulated data block to form a composite data block and a transmitter for transmitting said composite data block.

According to a sixth aspect of the present invention there is provided a receiver for receiving a composite data block sent from a first station to a second station comprising a divider for separating the composite data block into component data blocks in dependence on the type of modulation scheme used to modulate data in each of the component data blocks and a demodulator for demodulating each component data block using a demodulation scheme corresponding to the modulation scheme used to modulate the data.

These and other objects, advantages and features of the invention, together with the organization and manner of operation thereof, will become apparent from the following detailed description when taken in conjunction with the accompanying drawings, wherein like elements have like numerals throughout several drawings described below.

### BRIEF DESCRIPTION OF THE DRAWINGS

For a better understanding of the present invention and to show how the same may be carried into effect, reference will now be made by way of example to the accompanying drawings in which:

FIG. 1 is a schematic diagram of a cellular wireless communications system;

FIG. 2 is a schematic diagram showing communication between user equipment, base station and radio network controller;

FIG. 3 is a block diagram of a conventional CP-SC transceiver;

FIG. 4 is a CP-SC data block structure according to the prior art;

FIG. 5 is another CP-SC data block structure according to the prior art;

FIG. 6a is a CP-SC data block structure in a transmitter according to an embodiment of the invention;

FIG. 6b is a CP-SC data block structure in a receiver according to an embodiment of the invention;

FIG. 7 presents the performance behaviours of alternative systems with the velocity as 30 km/h;

FIG. 8 presents the performance behaviours of alternative systems with the velocity as 120 km/h;

FIG. 9 presents the performance behaviours of alternative systems with the velocity as 250 km/h;

FIG. 10 shows a schematic representation of a transceiver according to an embodiment of the present invention;

FIG. 11 shows a flow diagram of the method steps carried out in accordance with an embodiment of the invention.

### DETAILED DESCRIPTION OF VARIOUS EMBODIMENTS

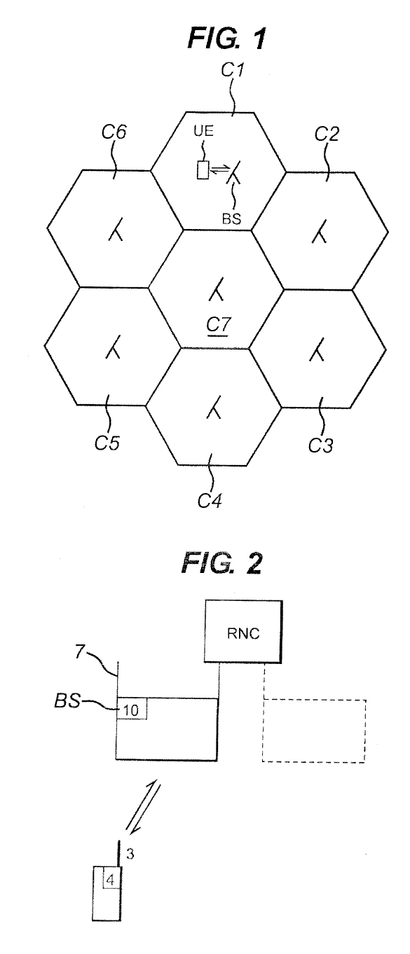

FIG. 1 illustrates a cellular wireless communications network of which seven cells C1 . . . C7 are shown in a “honeycomb” structure. Each cell is shown managed by a base station BS which is responsible for handling communications with user equipment (UE) located in that cell. Although one base station per cell is shown in FIG. 1, it will readily be appreciated that other cellular configurations are possible, for example with a base station controlling three cells. Also, other arrangements are possible, including a network divided into sectors, or a network where each cell is divided into sectors. User equipment UE1 communicates with the base station BS via a wireless channel 2 having an uplink and a downlink. The base station BS is responsible for processing signals to be communicated to the user equipment UE and as will be described in more detail in the following.

FIG. 2 is a schematic block diagram showing a user equipment in communication with a base station, and also showing a radio network controller RNC which manages the operation of a plurality of base stations in a manner known in the art. The user equipment UE comprises an antenna 3 connected to a transceiver 4. The base station also has an antenna 7 connected to a transceiver 10. The radio network controller RNC is connected to the base station BS and to other base stations indicated diagrammatically by the dotted line.

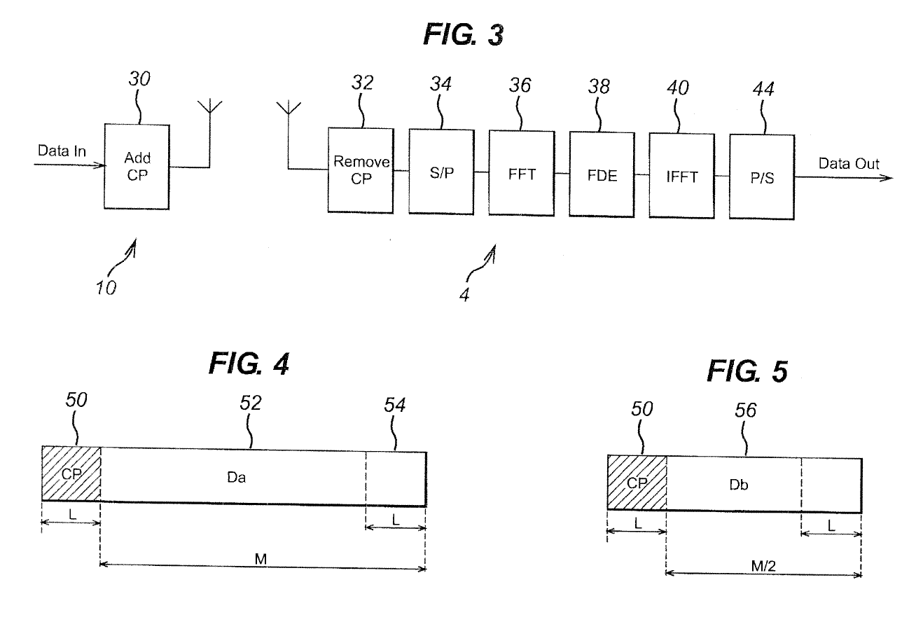

Reference will now be made to FIG. 3 to describe a CP-SC transceiver according to the prior art. FIG. 3 shows the transmitter section of the transceiver 10 of the base station BS and the receiver section of the transceiver 4 of the user equipment UE. It will be readily appreciated that the transmitter and receiver sections described may be present in both the BS and UE.

After the data is encoded and modulated, the data is input into the Add CP block 30. The data may be encoded by any type of channel encoder (not shown) and the signal may be modulated by any modulation alphabet, e.g. PSK, QAM. The Add CP block 30 appends a cyclic prefix (CP) to each data block. The CP is actually a copy of the last portion of the data block. The length of the CP is greater than the maximum delay spread. The signal is then up-converted and transmitted.

An example of the data block structure with the CP added is shown in FIG. 4. FIG. 4 shows a data block Da 52 of size M. The appended CP 50, of length L, is a copy of the last portion of the data block 54.

Returning to FIG. 3, when the signal is received at the receiver, the Remove CP block 32 removes the CP based on time synchronization to avoid inter-block interference (IBI). Next, the data block is processed by Fast Fourier Transform (FFT) at block 36. The frequency selective fading channel due to multi-path fading is transformed into parallel flat-faded independent sub-carriers. Assuming that the sub carrier spacing is smaller than the channel coherence frequency the channel is equalized by one tap FDE at block 38.

The equalized signal is then transformed back into a time domain signal by the IFFT block 40. The time-domain received signal with the CP removed in a CP-SC system can be expressed as:

y=Hx+n (1)

where y, x and n are the M size received signal vector, the transmitted signal vector and the noise vector in each data block of size M, respectively. H is the time varying cyclic convolution channel matrix such as,

$$H = [ \begin{matrix}{h}_{1 , 1} … {h}_{- 1.3} {h}_{0 , 2} \\ {h}_{1 , 2} {h}_{2 , 1} … {h}_{0 , 3} \\ … \\ …0… \\ {h}_{1 , L} … \\ … \\ … {h}_{M - 1 , 1} \\ 0 … {h}_{M - L + 1 , L} … {h}_{M - 1 , 2} {h}_{M , 1}\end{matrix} ] \qquad ( 2 )$$

where the element hᵢⱼ implies for the channel response of j-th path at i-th symbol period, L is the number of paths and M is the size of the data block.

When the channel varies slowly and remains quasi static during the same data block, H can be approximately seen as a constant cyclic convolution matrix so which gives:

H=Ω*ΛΩ (3)

where Λ is a diagonal matrix and Ω is an M-size FFT matrix.

Returning to FIG. 4, where Da is the transmitted data in the block of size M, and the CP length is L, the bandwidth efficiency is:

M/(M+L) (4)

However in a fast fading channel, especially one which varies within the same data block, equation 3 cannot be modelled as an approximate solution for channel matrix H. This results in significant performance degradation with one tap FDE.

One solution is to reduce the length of the block size. However as discussed in relation to Type III algorithms, this reduces the bandwidth efficiency since the length of the CP is not reduced. This is shown in FIG. 5.

FIG. 5 shows a transmitted data block 56 of size M/2 to resist high Doppler. The data Db is carried in the data block and a CP 50 of length L is appended to the data block 56. This results in the decreased system bandwidth efficiency of:

M/(2L+M) (5)

An embodiment of the invention will now be described showing a CP SC system for high Doppler which has the same bandwidth efficiency as the conventional system.

In accordance with an embodiment of the present invention, a higher modulated CP is proposed to shorten the data block length.

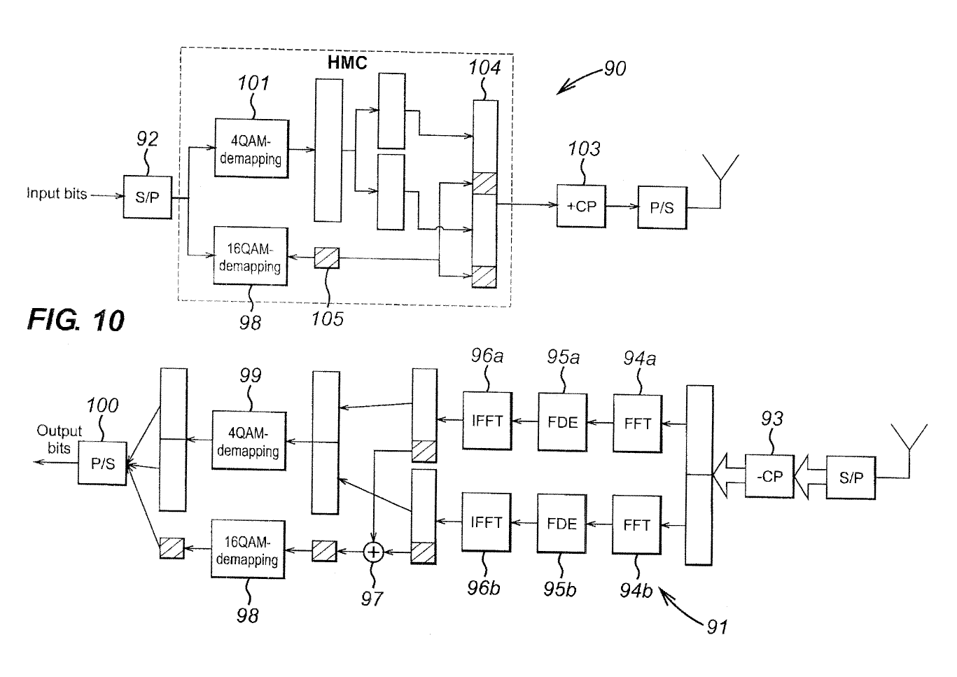

Reference is now made to FIG. 10 which shows a CP-SC transceiver according to an embodiment of the present invention. FIG. 10 shows the transmitter section 90 of the transceiver of the base station BS and the receiver section 91 of the transceiver of the user equipment UE. It will be readily appreciated that the transmitter and receiver sections described may be present in both the BS and the UE.

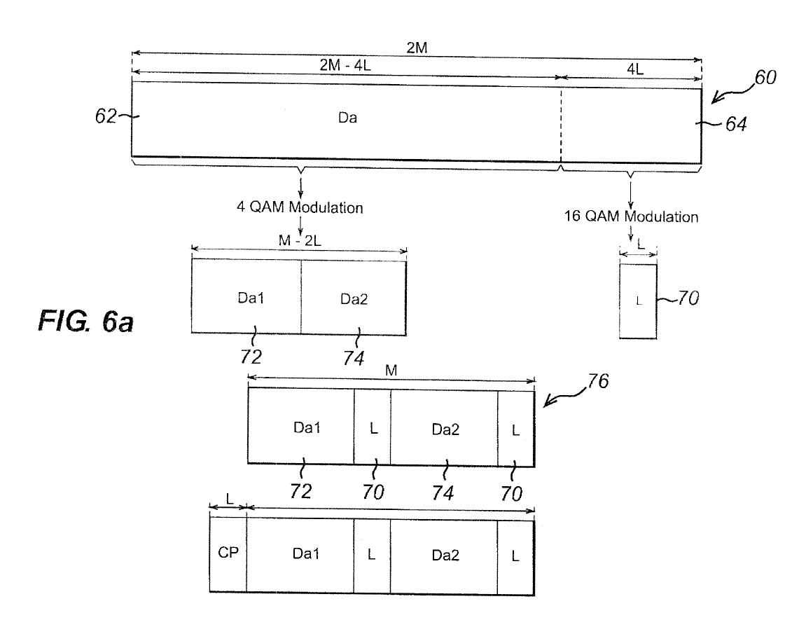

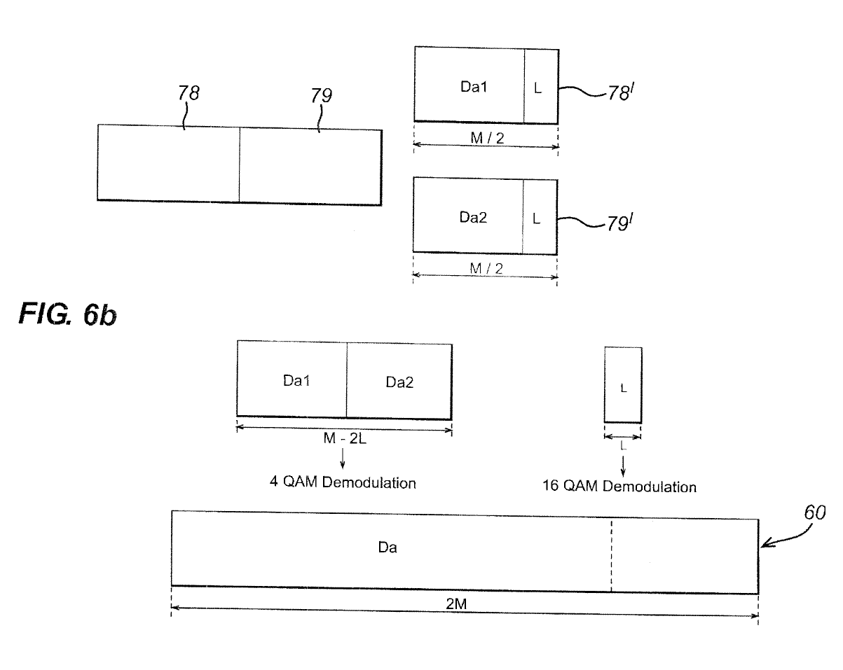

FIG. 6a shows the data block at different stages of processing in the transmitter. FIG. 6b shows the received data block at different stages of processing in the receiver. Reference will now be made to both FIG. 10 and FIGS. 6a and 6b to describe an embodiment of the present invention.

As shown in FIG. 6a, the original data block with data Da 60 of size 2M is defined as:

x=[x₁x₂ . . . x_{2M}]^{T} (6)

where xₙ represents a data bit and superscript T represents transposing.

According to an embodiment of the present invention the original data block is divided into parts. Each part is input into a different modulator, one modulator being a higher order modulator than the other modulator. The higher modulated part is used as the CP.

According to one embodiment of the invention, at the transceiver, data block Da 60 is input into a serial to parallel converter block 92. The 2M bits of data block 60 are then separated into two parts; a first part 62 of length 2M−4L and a second part 64 of length 4 L.

The first part 62 is modulated by a first modulation scheme. In FIG. 10, the first part 62 is input into 4QAM modulator 101. By applying a 4QAM modulation to the first part 62 of the data block, the first part 62 is segmented into two consecutive sub-blocks Da1 72 and Da2 74. Furthermore the 4QAM modulation reduces the total length of the first part 62 by half. Accordingly the total length of the two consecutive sub-blocks Da1 and Da2 is (2M−4L)/2) or M−2L.

In accordance with an embodiment of the invention the modulation scheme applied to the first part 62 of the data block divides the data block into a plurality of sub blocks. In a further embodiment of the invention the applied modulation scheme reduces the length of the first part of the data block.

In a further embodiment of the invention, in the case where the Doppler is very high, the first part 62 of the data block can be broken into more than two sub-blocks. The number of sub blocks the data block is broken into is dependent on the type of modulation scheme used. For example the data block may be broken into four sub-blocks, in this case 64QAM modulation is needed.

The second part 64 of the data block is defined as:

[x_{2M-4L+1}x_{2M-4L+2} . . . x_{2M}]^{T}

The second part 64 of the data block is input into a higher order combination (HMC) modulator.

According to an embodiment of the invention the second part 64 is input into 16QAM modulator 102. Applying a 16QAM modulation to the 4L bits, results in a block 70 of length L.

Block 70 of length L is then copied. In one embodiment of the invention block 70 may be stored temporarily in a memory 105 in the transmitter 90 before block 70 is combined with the remaining part of the data block.

The two copies of the higher order modulated block 70 of length L are then appended to the ends of blocks Da1 72 and Da2 74 at combiner 104 to form a combined data block 76 of length M as shown in FIG. 6a. The combined data block 76 is then input into an Add CP block 103 where a further copy of the higher order modulated block 70 is also inserted at the start of block Da1 72 as the cyclic prefix (CP) before the data is transmitted.

As can be see seen from FIG. 6a, the bandwidth efficiency is:

M/(M+L) (7)

This is the same as the efficiency of the conventional system given in equation (4). However, since each data block is length M/2 the system is more robust to high Doppler.

In further embodiments of the present invention the data block can be split into 4 or 8 sub-blocks thereby increasing the systems resistance to high Doppler. A higher-order modulation must then be applied to maintain the same spectrum efficiency.

FIG. 6b shows how the received data block is processed when it is received in the receiver 91. Reference will also be made to FIG. 10 to describe the receiver.

In accordance with an embodiment of the invention the receiver 91 is arranged to divide the composite data block into the same number of sub blocks that resulted from the modulation of the first part 62 of the data block in the transmitter.

According to one embodiment of the invention the type of modulation is predefined and the receiver has knowledge of the type of modulation used in the receiver.

According to another embodiment of the invention modulation information may be transmitted from the transmitter to the receiver.

When the signal is received at the receiver 91, the Remove CP block 93 removes the CP. The received signal block is then divided into two sub blocks 78 and 79.

After dividing the received signal block into two sub blocks 78 and 79, the sub-blocks are processed separately in two paths of the receiver arranged in parallel. The first path for equalising the sub block 78 contains an M/2 sized FFT block 94a, FDE block 95a and IFFT block 96a. The second path for equalising the second sub block 79 contains an M/2 sized FFT block 94b, FDE block 95b and IFFT block 96b.

In one embodiment of the invention the number of processing paths provided in the receiver is dependent on the number of sub blocks that the composite data block is divided into.

Sub block 78′ output from the IFFT block 96a contains the first sub block Da 1 72 together with block 70 of length L. Sub block 79′ output from the IFFT block contains the second sub block Da 2 74 together with another copy of block 70.

According to an embodiment of the invention, since the receiver is aware of the type of modulation used in the transmitter, the receiver has knowledge of the length of each sub block. After the receiver synchronises the received frames the data in each sub block can be determined by the length of the data.

The higher modulated block 70 of length L is then removed from each of the sub blocks and combined in combiner 97 before being input into 16QAM de-mapping block 98 to be demodulated. Meanwhile, the first and second sub blocks 78 and 79 are input into a 4QAM de-mapping block 99 to be demodulated.

The output of the two modulators is then combined and input into a parallel to serial block 100, resulting in data block Da of length 2M.

In alternative embodiments of the invention there may be a different number of modulators and equaliser paths in the receiver. It should be appreciated that the number of modulators and equaliser paths in the receiver is dependent on the number of sub blocks.

Due to the higher order modulation, the Energy per bit per noise power spectral density (EbNo), which defines Spectral Noise Density (SNR) per bit, will decrease. This loss is compensated for in the receiver which combines the repeated high order modulation blocks L in combiner 97. For example, the equal gain combining (EGC) can be utilized in the combiner to compensate the EbNo loss. Alternatively other combining schemes such as maximum ratio combining (MRC) can be also be applied in combiner 97.

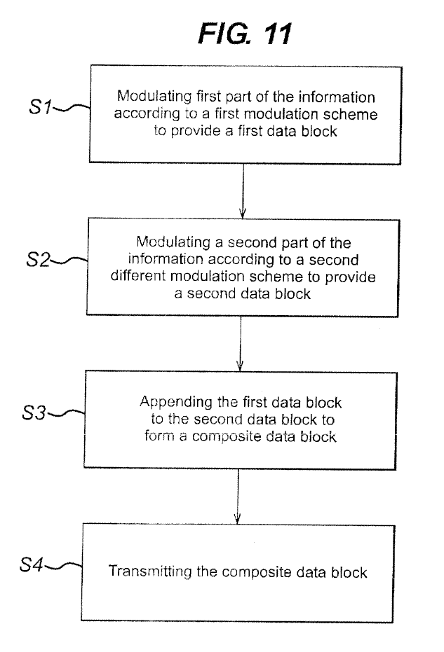

FIG. 11 is a flow chart showing the general method steps carried out in the transmitter in accordance with an embodiment of the invention.

In step S1 the first part of the information is modulated according to a first modulation scheme to provide a first data block.

In step S2 the second part of the information is modulated according to a different modulation scheme to provide a second data block.

In step S3 the first data block is appended to the second data block to form a composite data block.

In step S4 the composite data block is transmitted.

Comparative results. Table 1 below compares the complexity of the conventional scheme and a scheme in accordance with the present invention.

TABLE 1
Complexity

| | |
|---|---|
| Conventional | 1 M sized FFT to convert received signal to freq. domain: |
| | (M/2)log M; One-tap FDE: M; 1 M sized IFFT to convert |
| | equalized signal to time domain: (M/2)logM; Total |
| | MlogM + M |
| Embodiment | 2 M/2 sized FFT to convert received signal to freq. domain: |
| | (M/2)log (M/2); One-tap FDE: 2 M/2; 2 M/2 sized IFFT to |
| | convert equalized signal to time domain: (M/2)log(M/2); |
| | Total Mlog(M/2) + M |

It is therefore shown that the implementation complexity could be reduced by around 11% by the embodiment of the invention in the case of M as 512.

As previously discussed, the bandwidth efficiency of the described embodiment of the invention with HMC is the same as that of the conventional system without shortening the data block. In the case of M as 512 and L as 16 the bandwidth efficiencies according to equations (4), (5) and (7) are 96.96%, 94.11% and 96.96% respectively

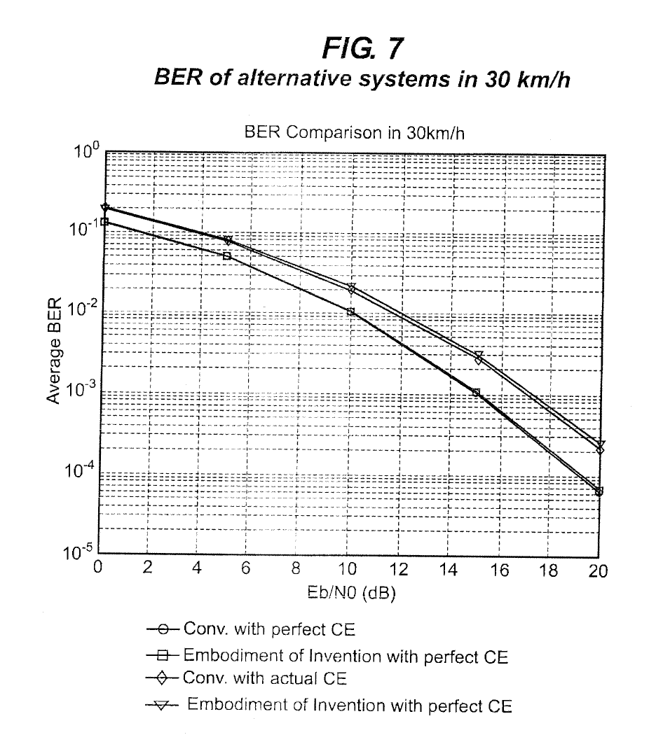

FIGS. 7, 8 and 9 are graphs which show the relative performance behaviours of alternative systems at velocities of 30, 120 and 250 km/h respectively. The graphs compare a conventional CP-SC system having 1024 symbols per block with QPSK to the HMC CP-SC system according to an embodiment of the invention having 1024 symbols with QPSK data and 16QAM assisted CP. The additional simulation parameters are listed in Table II below.

TABLE II

| | |
|---|---|
| Sampling Rate | 5 M Hz |
| CP Length | 8 symbols |
| Path Number | 8 with maximum delay spread as 8 |
| Carrier Frequency | 3 G Hz |
| Channel Profile | ITU VA Channel |

FIG. 7 is a graph showing the performance behaviours of alternative systems with the velocity as 30 km/h. In relatively low Doppler environment the channel is quasi-static within one data block so that there is no need to shorten the data block to resist Doppler induced interference. The HMC scheme according to an embodiment of the invention has approximately the same performance as the conventional one. The slight loss in the embodiment according to the invention is due to EbNo loss due to the higher order modulation which cannot be fully recovered by diversity combining.

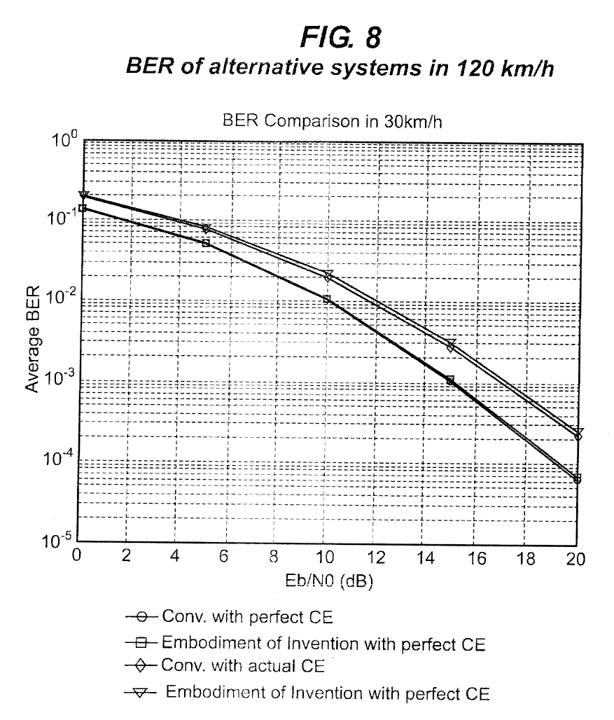

FIG. 8 shows the performance behaviours of the systems at 120 km/h. It can be seen that the HMC CP-SC embodiment according to the present invention outperforms the conventional CP-SC scheme by around 0.5/1 dB with actual/ideal channel estimation due to robustness to Doppler induced ICI.

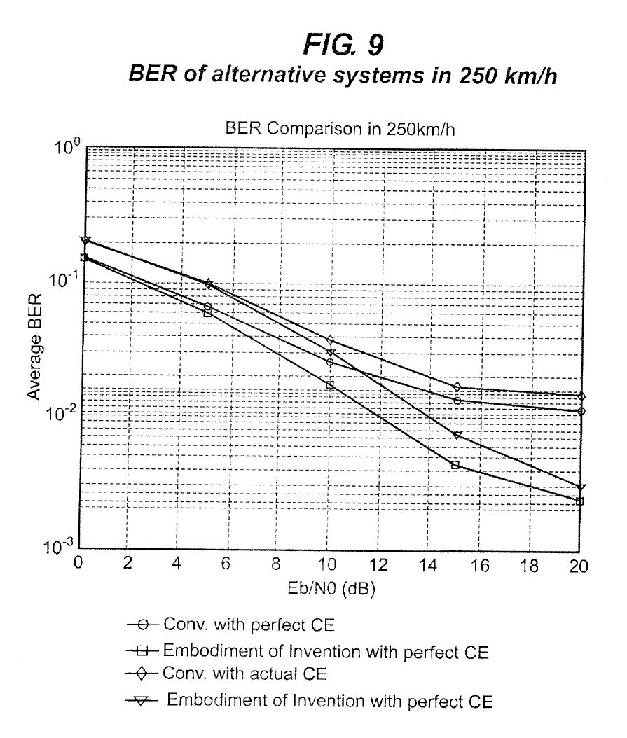

FIG. 9 shows the performance behaviour of the systems at a velocity of 250 km/h. As can be seen, the HMC scheme according to an embodiment of the invention considerably improves the system performance.

The required data processing functions in the above described embodiments of the present invention may be implemented by either hardware or software. All required processing may be provided in a centralised controller, or control functions may be separated. Appropriately adapted computer program code products may be used for implementing the embodiments, when loaded to a computer, for example for computations required when combining the sub blocks to form a composite block. The program code product for providing the operation may be stored on and provided by means of a carrier medium such as a carrier disc, card or tape. Implementation may be provided with appropriate software in a control node.

The present invention is described in the general context of method steps, which may be implemented in one embodiment by a program product including computer-executable instructions, such as program code, executed by processor and computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

What is claimed is:

1. A method for transmitting information in a communication system from a first station to a second station, comprising:
modulating a first part of the information according to a first modulation scheme to provide a first modulated data block;
modulating a second part of the information according to a second different modulation scheme to provide a second modulated data block;
appending the first modulated data block to the second modulated data block to form a composite data block; and
transmitting the data block.

2. A method as claimed in claim 1, wherein the second modulation scheme is a higher order modulation than the first modulation scheme.

3. A method as claimed in claim 1, wherein the second modulated data block forms a cyclic prefix.

4. A method as claimed in claim 3, wherein the second modulated data block also forms part of a data portion in the composite data block.

5. A method as claimed in claim 1, wherein the second modulated data block is repeated in the composite data block.

6. A method as claimed in claim 1, wherein the modulating of the first part of the information forms a plurality of first modulated data blocks.

7. A method as claimed in claim 6, wherein the number of first modulated data blocks that are formed is dependent on the type of modulation scheme that is used.

8. A method as claimed in claim 6, wherein the second modulated block is appended to each of the plurality of first modulated data blocks to form the composite data block.

9. A method as claimed in claim 1, wherein the first modulation scheme is a 4 QAM modulation scheme.

10. A method as claimed in claim 1, wherein the second modulation scheme is a 16 QAM modulation scheme.

11. A method as claimed in claim 1, wherein the second modulation scheme is a higher order combination modulation scheme.

12. A method of receiving a composite data block sent from a first station to a second station, comprising:
separating component data blocks of the composite data block in dependence on a type of modulation scheme used to modulate data in each component data block; and
demodulating each component data block using a demodulation scheme corresponding to the modulation scheme used to modulate the data.

13. A transmitter for transmitting information in a communication system, comprising:
first modulating means for modulating a first part of the information according to a first modulation scheme to provide a first modulated data block;
second modulating means for modulating a second part of the information according to a second modulation scheme to provide a second modulated data block;
means for appending the first modulated data block to the second modulated data block to form a composite data block; and
transmitting means for transmitting the composite data block.

14. A transmitter as claimed in claim 13, wherein the second modulating means is a higher order modulator than the first modulating means.

15. A transmitter as claimed in claim 13 further comprising means for appending a copy of the second modulated data block as a cyclic prefix to the composite data block.

16. A transmitter as claimed in claim 13 wherein the first modulating means is a 4 QAM modulator.

17. A transmitter as claimed in claim 13, wherein the second modulating means is a 16 QAM modulator.

18. A transmitter as claimed in claim 13, wherein the second modulating means is a higher order combination modulator.

19. A mobile phone comprising the transmitter of claim 13.

20. A base station comprising the transmitter of claim 13.

21. A receiver for receiving a composite data block sent from a first station to a second station comprising:
a determiner configured to determine component data blocks of the composite data block in dependence on the type of modulation scheme used to modulate data in each of the component data blocks; and
a demodulator configured to demodulate each component data block using a demodulation scheme corresponding to the modulation scheme used to modulate the data.

22. A mobile phone comprising the receiver of claim 21.

23. A base station comprising the receiver of claim 21.

24. A transmitter for transmitting information in a communication system comprising:
a first modulator configured to modulate a first part of the information according to a first modulation scheme to provide a first modulated data block;
a second modulator configured to modulate a second part of the information according to a second different modulation scheme to provide a second modulated data block;
a combiner configured to append the first modulated data block to the second modulated data block to form a composite data block; and
a transmitter configured to transmit the composite data block.

25. A computer program comprising program code, embodied in a computer-readable medium, for performing the processes of claim 1 when the program is run on at least one of a computer and a processor.
